(19) United States
(12) Patent Application Publication
(10) Pub. No.: US 2011/0211925 A1
(43) Pub. Date: Sep. 1, 2011

(54) Method for Generating a Thread by a Tool machine, Coupling Device and Tool Machine

(75) Inventor: Peter Liebald, Hilpolstein (DE)

(73) Assignee: EMUGE-Werk Richard Glimpel GmbH & Co. KG Fabrik fur Prazisionswerkzeuge, Lauf (DE)

(21) Appl. No.: 13/034,634

(22) Filed: Feb. 24, 2011

(30) Foreign Application Priority Data
Feb. 25, 2010 (DE) DE 102010009349.1

(51) Int. Cl. B23G 1/18; B23C 5/26; B23C 5/28; B23G 3/00

(52) U.S. Cl. 409/66; 409/232; 409/136; 409/67

(57) ABSTRACT

The invention relates to a method for generating a thread by a numerically-controlled tool machine (or: machine tool) using a thread generation tool, the thread generation tool being rotated by a tool spindle and simultaneously advanced according to the thread pitch in the axial direction, in order to generate a thread in a borehole of a workpiece. In order to increase the working velocity of the thread generation, the invention provides that the rotational velocity (ω₁) of the thread generation tool is geared up using a transmission gearing, which is situated so it is active between tool spindle and thread generation tool, in relation to the rotational velocity (ω₂) of the tool spindle. Furthermore, the invention relates to a numerically-controlled machine tool.

The invention relates to a method for generating a thread by a tool machine (or: machine tool), which is numerically controlled in particular, having a thread generation tool, the thread generation tool being rotated by a tool spindle to generate a thread in a borehole, the thread generation tool and the borehole being moved toward one another or one inside the other simultaneously according to the thread pitch. Furthermore, the invention relates to a coupling device and a machine tool, which is numerically controlled in particular.

In a method of the kind, a pin-shaped thread cutting tool is inserted into the chuck of a tool spindle of a machine tool, in order to cut a thread in a pre-drilled borehole. For this purpose, the thread generation tool is not only rotationally driven by the tool spindle, it is also advanced in the axial direction relative to the workpiece, the axial displacement path resulting from the rotational movement of the tool spindle on the basis of the desired or required thread pitch. Accordingly, a precise, synchronous coupling of the rotational movement and the axial movement is required, which can be caused by the numeric controller of the machine tool, for example.

In typical tool machines (or: machine tools), a synchronization limit or maximum rotational speed of the tool spindle results, up to which the mentioned synchronization of the rotational movement of the tool and its axial advance are ensured. Depending on the signal processing time of the machine controller, this maximum rotational speed cannot be exceeded, even in the case in which a higher rotational speed is specified by the operator, since the machine or its controller is not capable of synchronizing the advance in a controlled way with the rotational speed at a higher rotational speed than the synchronization limit.

The fact that the rotational speed during thread generation does not reach the rotational speed set by the operator at all is not even noticeable under certain circumstances, since because of the limited thread length and therefore the limited number of revolutions, which is a function of the thread length and the pitch of the thread to be generated, the processing time for generating the thread is so short that the maximum set rotational speed is not even reached or the display of the rotational speed on the machine display is so imprecise because of the dynamic character of the thread cutting that the operator cannot perceive the deviation of the actual rotational speed from the predefined rotational speed at all. Because of the continuous accelerations and decelerations during thread generation in the forward direction using a first rotational direction and in the reverse direction when unscrewing the thread generation tool from the cut thread in the opposite rotational direction, a persistent state having uniform rotational speed is practically never reached and therefore a persistent value, which is displayed for a sufficiently long time for the rotational speed to be noticed by the operator, is also never provided.

Approximately only half of the thread depth is available for the acceleration of the tool spindle, until the tool spindle must be decelerated again.

It is accordingly disadvantageous that without large expenditure for the machine controller having the cited limiting of the synchronization velocity between rotation and axial advance of the tool spindle, the maximum rotational velocity of the thread generation tool and therefore also the generation velocity of the tool are limited. Corresponding limitations therefore also exist for the cost-effectiveness of the method.

The invention is based on the object of refining a method of the type mentioned at the beginning and a corresponding tool machine (or: machine tool) in such a way that it is possible, at a given performance capability of the machine controller with respect to its synchronization capability, to achieve shorter cycle times during the thread generation. It should also be possible to improve the cost-effectiveness of the method.

The achievement of this object by the invention is characterized according to the method in that the rotational velocity of the thread generation tool is geared up in relation to the rotational velocity of the tool spindle using a transmission gearing situated so it is active between tool spindle and thread generation tool.

Correspondingly, a coupling device for a tool machine (or: machine tool), which is numerically controlled in particular, for generating a thread using a thread generation tool is provided, the coupling device having at least one tool spindle, which is connected so it is rotatable to a tool receptacle, a transmission gearing, which is implemented to gear up the rotational velocity of the tool spindle, being situated so it is active between the tool spindle and the tool receptacle.

Since the synchronization limit of the respective tool machines (or: machine tools) in use cannot be changed without greater expenditure, it is thus proposed according to the invention that a transmission gearing be switched or situated between the machine spindle of the tool machine (or: machine tool) and the tool chuck for the thread generation tool, the transmission gearing converting the rotation of the tool spindle into a corresponding rotation of the tool chuck at a predefined transmission ratio, the rotational velocity of the rotation of the tool chuck being converted into the rotational velocity of the tool spindle by a transmission factor of preferably greater than 1.

The generation of the thread can be performed according to the invention by cutting (thread cutting) or forming (thread forming), for example.

The transmission gearing preferably has a single fixed transmission ratio. It can be implemented as an intermediate gear transmission.

The transmission gearing preferably has a ring, in particular an inner ring, which is coupled in a rotationally-fixed way to the spindle, at least one gearwheel being situated so it is rotatable in or on the ring. The at least one gearwheel preferably engages on the inner side in a further gearwheel, in particular an inner gearwheel, which is coupled to the collet in a rotationally-fixed way. The inner ring is particularly preferably enclosed by an outer ring, the outer ring further being able to have a peripheral sprocket on the inner side, so that at least one gearwheel engages or can engage on the outside in the sprocket.

In contrast to the milling tool, which essentially rotates at the same rotational speed and always in the same rotational direction, in the case of thread generation, a permanent change is to be noted between acceleration and deceleration of the tool and a rotational direction change is to be noted upon reaching the deepest point in the threaded hole and the retraction of the thread generation tool. Because of the use of the transmission gearing proposed according to the invention, the measuring errors and the synchronization errors when measuring the rotational angle of the tool can rise in accordance with the transmission factor of the transmission gearing, since the measuring resolution of the machine remains unchanged.

Therefore, a preferred refinement of the invention provides that an element which is elastic in the axial direction is situated so it is active between the tool spindle and the thread generation tool. The elastic element can be formed by a component made of elastomeric material or rubber material; alternatively, a spring element made of spring steel is also possible as an elastic element. The increased measuring errors or synchronization errors can thus be kept harmless in that a certain axial elasticity of the thread generation tool to the tool spindle is ensured. Accordingly, a minimum length compensation chuck is proposed, which is situated between the transmission gearing and the thread generation tool, for example, to allow a compensation in case of errors. In this regard, reference is made to EP 0 887 135 A1, in which a concrete design solution for such a compensation chuck having axial yielding is disclosed.

Furthermore, the transmission gearing can be situated having a housing part on a torque support so it is fixed in place in the rotational direction, but is displaceable in the axial direction. A preferred embodiment provides in this case that the torque support comprises a guide rod extending in the axial direction, on which a housing part is supported. For this purpose, a friction or roller bush can be situated on the housing part, in which the guide rod is mounted so it is axially displaceable.

Therefore, a torque support is provided for absorbing or supporting torques on the fixed part or on the housing of the transmission gearing which—in contrast to the torque supports, which are only active in one rotational direction, in common high-speed armatures in milling technology—is fixed in location without play. The torque support must support torques in both rotational directions during thread generation, because of which it must be fixed in place against the housing in both rotational directions; the axial advance movement must certainly be permitted if the thread generation tool is moved axially and the workpiece is not moved instead.

A transmission gearing which is known per se and is optionally modified can be used as the transmission gearing, which is known as a “high-speed armature,” as a “milling cutter drive,” or as an “intermediate gear” for milling tools.

A coolant duct, which is guided in the area of the transmission gearing in a coolant pipe, preferably runs centrally through the tool spindle to the tool receptacle. The coolant pipe is particularly preferably mounted in bearings in the tool spindle and in the tool receptacle, the coolant pipe rotating in operation at a rotational speed in relation to the tool spindle and/or the tool receptacle at the level of the difference of the rotational velocity of the tool spindle and the rotational velocity of the tool receptacle. The coolant pipe is preferably fixed in a rotationally-fixed way on the tool receptacle. Alternatively or additionally to this preferred coolant supply, an embodiment for minimum quantity lubrication is also possible or advantageous.

Furthermore, the invention relates to a tool machine (or: machine tool) for generating a thread using a thread generation tool, in particular a numerically-controlled tool machine (or: machine tool), having a coupling device according to the invention.

Preferably, the or a thread generation tool can be rotated using the tool spindle and simultaneously advanced according to the thread pitch in the axial direction, in order to generate a thread in a borehole of a workpiece.

The invention is described in greater detail hereafter on the basis of exemplary embodiments, which are shown in FIGS. 1 to 9.

### IN THE FIGURES

FIG. 1 shows a schematic view of a part of the machine tool according to the invention,

FIGS. 2 to 6 show a torque support according to the invention,

FIG. 7 shows a first embodiment of the coupling device for the machine tool according to the invention in a sectional view,

FIG. 8 shows the first embodiment according to FIG. 7 in a second sectional view, which is orthogonal to the first sectional view, and

FIG. 9 shows a second embodiment of the coupling device for a machine tool according to the invention in a sectional view.

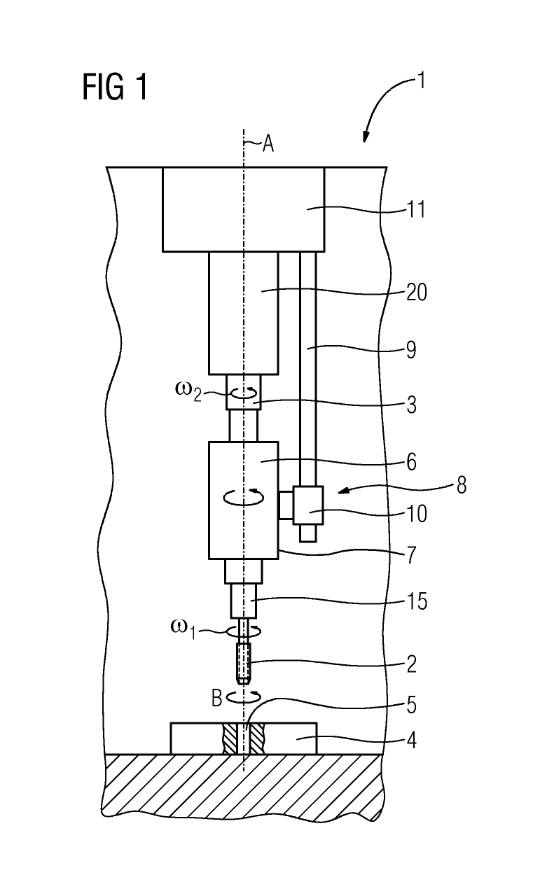

FIG. 1 schematically shows the coupling device 20 according to the invention of a machine tool 1. The carriage 11 of the tool machine (or: machine tool) 1 receives a rotatable tool spindle 3 on its lower end, which is oriented toward a thread generation tool 2. Furthermore, the carriage 11 has a downwardly oriented guide rod 9 laterally on the lower end.

The tool spindle 3 is coupled so it is rotatable to a transmission gearing 6, on which a collet (or: tool receptacle) 15 is coupled in the direction toward the thread generation tool 2. A thread generation tool 2, which can execute a threaded borehole 4 in a workpiece 5, is located in the collet 15.

The spindle 3 rotates at a rotational speed ω₂, the collet 15 and the thread generation tool 2 rotate at a rotational velocity ω₁.

The tool machine (or: machine tool) 1 is implemented as a numerically-controlled machine, the tool spindle 3—which is numerically controlled—not only executing a rotational movement around an axis B, but rather also being able to be moved translationally in the axial direction A in a numerically controlled way. If an axially advancing movement along the axis A is superimposed on the rotational movement around the axis B, a helical line results. This is required if a thread is to be cut into the workpiece 5 having the borehole 4.

For this purpose, the thread generation tool 2 is connected to the tool spindle 3 and the thread generation is performed in a way known per se.

It is essential that the transmission gearing 6 is situated so it is active between the tool spindle 3 and the thread generation tool 2. The transmission gearing 6 is implemented to gear up the rotational velocity ω₂ of the tool spindle 3. Accordingly, the rotational velocity ω₁ of the thread generation tool 2 results as

ω₁=ω₂×i,

where i is the transmission ratio of the transmission gearing 6 and is greater than one.

In operation, a torque, which must be supported, around the axis B is applied to the transmission gearing 6. For this purpose, a torque support 8 is provided, which comprises the guide rod 9, which is fixed in location on the carriage 11 of the tool spindle 3 and extends downward until it is lateral to the transmission gearing 6.

The transmission gearing 6 is situated in a housing 7. A torque support 8, which has an internal through borehole 10, is fixed laterally on the housing 7. The guide rod 9, which is in turn connected in a rotationally-fixed way to the spindle 3, is inserted into the through borehole 10 of the torque support 8. Accordingly, the transmission gearing 6 can slide in the axial direction A, but it cannot also rotate around the axis B, so that a torque support is implemented.

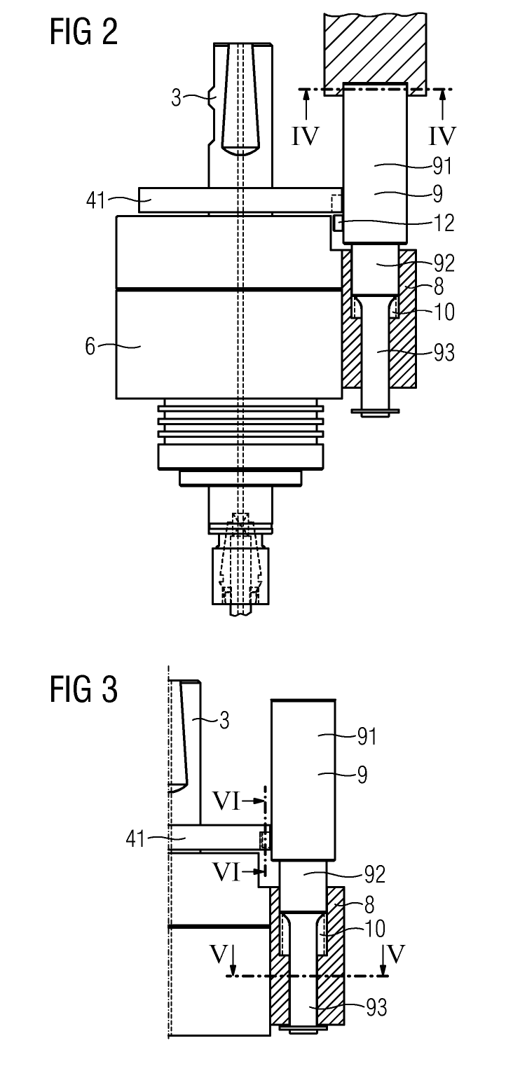

FIGS. 2 to 6 show an exemplary embodiment of the torque support 8 according to the invention in detail. FIGS. 2 and 3 show the position of the guide rod 9. The guide rod 9 has an essentially cylindrical shape and comprises three sections 91, 92, and 93, their diameter being reduced in steps downward from one section to the following one. The diameter of the guide rod 9 is thus reduced in a first step after approximately half of its length from the first section 91 to the second section 92, and is decreased again after approximately two-thirds of its length in a second step from the second section 92 to the third section 93. The second step is partially rounded. The section 93 of the guide rod 9 having the smallest diameter which results in the lower part is countersunk in the torque support 8 in a through borehole 10, which also has a diameter which tapers downward.

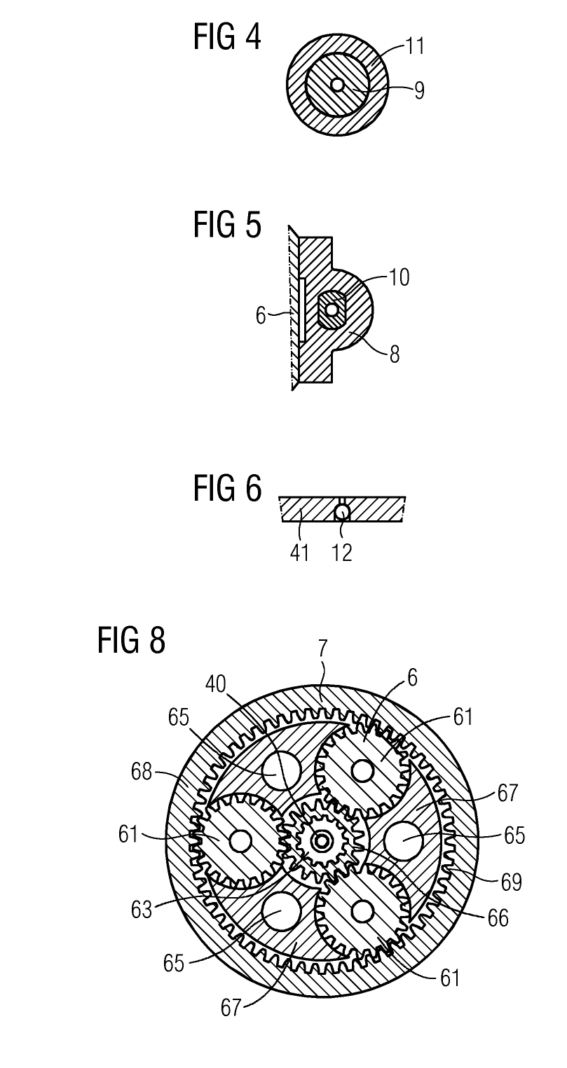

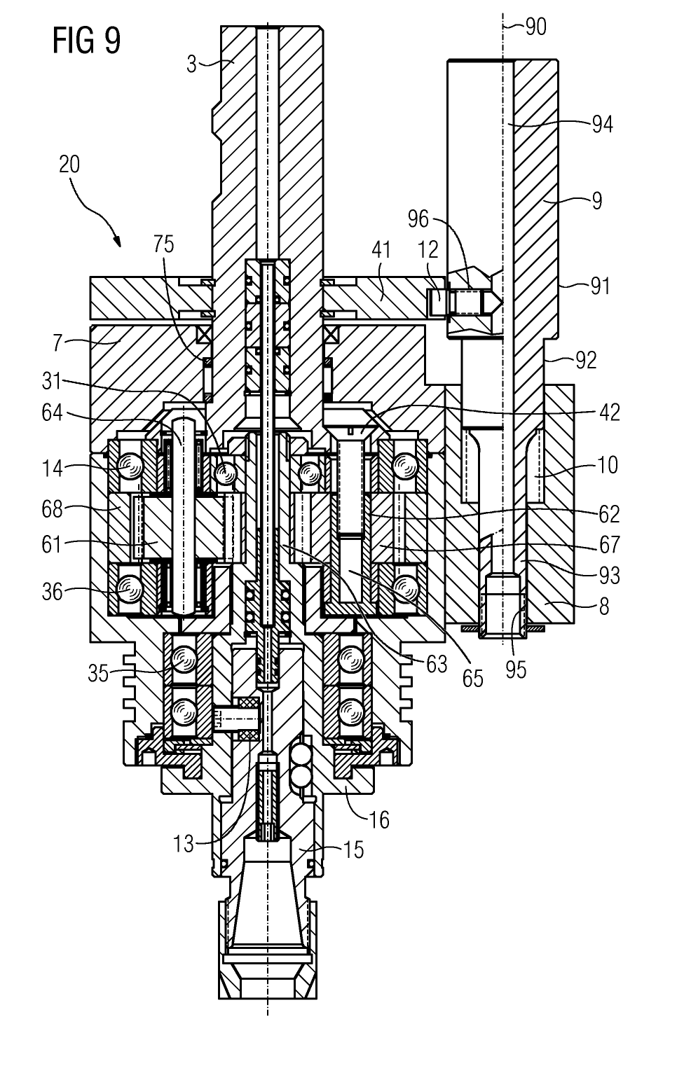

The guide rod 9 in turn has a first borehole 94, which is obvious from FIGS. 7 and 9, along its axis 90. The borehole 94 widens toward the lower end up to a thread 95. An adapter for receiving a coolant pipe (not shown) can be screwed into the thread 95. Coolant medium can be conducted to the thread generation tool 2 using this coolant pipe via the transport lock.

Furthermore, in the upper part of the first section 91 having the greatest diameter, the guide rod 9 has a second, radially running borehole 96, which extends transversely to the first borehole 94 and receives a locking element 12.

To prevent the guide rod 9 from rotating with the locking element 12, the third section 93 is implemented having two plane-parallel surfaces, which is obvious in FIG. 5.

FIG. 2 shows the guide rod 9 in a position during operation of the spindle 3. In this case, the spindle 3 is freely rotatable in relation to the support 9, since the locking element 12 is not connected to the spindle 3.

FIG. 3 shows the torque support 8 in position fixed in relation to the spindle 3. This is the position with the high-speed armature removed. In this case, the guide rod 9 is displaced upward, so that the locking element 12 fixes the spindle 3 in its angular location. A ring 41, which revolves with the spindle 3 above the housing 6, on its side facing away from the collet 15 and has a recessed area on its outer side, in which the locking element 12 can engage with the spindle for the purpose of fixing, is used as the coupling element between locking element 12 and spindle 3.

FIGS. 4 to 6 show sections through the torque support according to the invention. It is recognizable from the position of the guide rod 9 that the torque support 8 absorbs the torque in both rotational directions.

FIG. 7 shows a cross-section through a coupling device 20 according to the invention for a machine tool.

Is again recognizable that the spindle 3 engages in the transmission gearing 6, from which the rotational speed ω₂ of the spindle is transmitted to the rotational speed ω₁ of the collet 15. The torque support 8 is fixed laterally on the transmission gearing 6, the locking element 12 of the guide rod 9 engaging in a recess of a ring 41 of the spindle 3 in this case, so that the spindle 3 is fixed in the angular location in relation to the torque support 8.

The engagement of the locking element 12 in the ring 41 prevents the angular location of the locking or torque support 8 from changing in relation to the apparatus of the tool changer in the tool spindle 3.

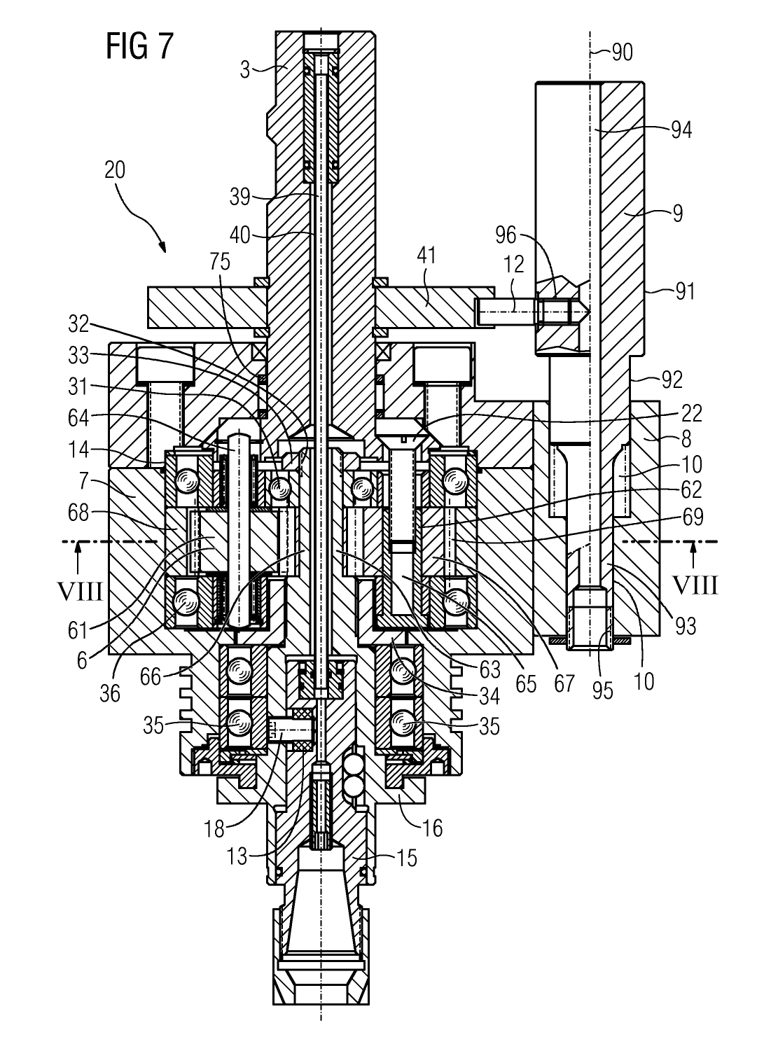

The internal structure of the gearing 6 is discussed hereafter, which is shown both in FIG. 7 and also, in a section perpendicular thereto, in FIG. 8.

The tool spindle 3 is mounted so it is rotatable on needle bearings 75 in relation to the housing 7 of the gearing 6 and is connected in a rotationally-fixed way to an inner ring 67 inside this housing 6. The inner ring 67 is mounted so it is rotatable inside a non-rotatable outer ring 68, which is connected in a rotationally-fixed way to the housing 7. The outer ring 68 forms a sprocket (or: gear rim) 69 on its inner side.

The inner ring 67 has multiple bearing pins 64 for gearwheels 61. The gearwheels 61 are situated along the periphery of the inner ring 67 and engage on their inner side in an inner gearwheel 66, which is coupled away from the spindle 3 in a rotationally-fixed way to a collet receptacle 16. The gearwheels 61 are guided on the outer side by the sprocket (or: gear rim) 69.

Furthermore, the inner ring 67 has boreholes 65, in each of which a screw 42 engages, which couples a pin 62 to the inner ring 67.

As the mount of the inner ring 67 inside the outer ring 68, bearings 14 and 36 are situated externally peripherally on the inner ring 67 above and below the gearwheels 61. The bearing pin 62 engages for this purpose between a clamping nut 34, which is fixed on the collet, as the axial support and the bearing 36.

The inner ring 67 is mounted around the spindle-side end area of the collet receptacle 16. For this purpose, internal bearings 31 are situated internally peripherally on the inner ring 67 above the gearwheels 61.

The gearwheels 61 are situated in a plane and have a bearing pin 64, using which they are mounted inside the inner ring 67.

The inner gearwheel 66 has a sprocket (or: gear rim) on the inner side, within which an innermost gearwheel 63 is fixed in a rotationally-fixed way, which is implemented as a spline shaft toward the thread generation tool 2 and merges into the collet receptacle 16, within which the collet 15 is received on the tool side. The innermost gearwheel 63 therefore forms a formfitting coupling with the inner gearwheel 66 and thus couples the collet 15 in a rotationally-fixed way to the inner gearwheel 66 of the gearing 6.

The collet receptacle 16 is mounted using a bearing 35 so it is also rotatable inside the housing 7.

A thread 32, on which a nut 33 is screwed to form an axial stop, is located on the spindle-side end of the collet receptacle 16.

The collet receptacle 16 has a lateral cylindrical borehole and receives a ring-shaped elastic element 13 therein, in which a threaded bolt 18 engages. The threaded bolt 18 is fixed inside the bearing 35. In this way, axial play results between collet 15 and collet receptacle 16.

A coolant duct 39, which is guided in operation of the transmission gearing 6 in a coolant pipe 40, runs centrally through the tool spindle 3 to the collet 15.

The above statements on the coupling device according to FIGS. 7 and 8 apply accordingly for the coupling device according to FIG. 9.

The coolant pipe 40 according to FIG. 7 is fastened by O-rings so it is axially displaceable inside the collet 15.

Furthermore, the coolant pipe 40 has multiple O-rings on its end oriented toward the spindle 3 for sealing in relation to the spindle 3, which must only form a static seal, since these O-rings are only loaded (or: strained) by the rotational speed difference ω₁−ω₂. Only a radial relative movement therefore results.

The coolant pipe 40 according to FIG. 9 is fastened inside the collet receptacle 16 and sealed by soldering or gluing. Furthermore, the coolant pipe 40 has O-rings, which are only loaded (or: strained) by the axial relative movement, for the mounting in relation to the collet 15.

Furthermore, the coolant pipe 40 has multiple O-rings on its end oriented toward the spindle 3 for sealing in relation to the spindle 3, which must only form a static seal, since these O-rings are only loaded (or: strained) by the rotational speed difference ω₁−ω₂. Only a radial relative movement therefore results.

### LIST OF REFERENCE NUMERALS

1 tool machine (or: machine tool)
2 thread generation tool
3 tool spindle
4 borehole
5 workpiece
6 transmission gearing
7 housing
8 torque support
9 guide rod
10 borehole
11 carriage
12 locking element
13 elastic element
14 transmission element
15 collet/tool receptacle
16 collet receptacle
18 threaded bolt
12 coupling device
22 screw
31 internal bearing
32 thread
33 nut
34 clamping nut
35 bearing
36 external bearing
39 coolant duct
40 pipe
41 ring
42 screw
61 gearwheel
62 connection bolt
63 innermost gearwheel
64 bearing pin
65 borehole
66 inner gearwheel
67 inner ring
68 outer ring
69 sprocket (or: gear rim)
75 needle bearing
90 axis
91 first section
92 second section
93 third section
94 first borehole
95 thread
96 second borehole
A axial direction
B rotational axis
ω₁ rotational velocity of the thread generation tool
ω₂ rotational velocity of the tool spindle

1-12. (canceled)

13. A method for generating a thread on a tool machine (or: machine tool), which is numerically controlled in particular, having a thread generation tool, the thread generation tool being rotated by a tool spindle in order to generate a thread in a borehole, comprising:
moving the thread generation tool and the borehole simultaneously toward one another, or one inside the other, according to the thread pitch;
wherein:
the rotational velocity (ω₁) of the thread generation tool is geared up in relation to the rotational velocity (ω₂) of the tool spindle using a transmission gearing which is situated so it is active between tool spindle and thread generation tool.

14. A coupling device for a machine tool, which is numerically controlled in particular, for generating a thread using a thread generation tool,
the coupling device having at least one tool spindle, which is connected to a tool receptacle so it is rotatable;
wherein:
a transmission gearing, which is implemented to gear up the rotational velocity (ω₂) of the tool spindle, is situated so it is active between the tool spindle and the tool receptacle.

15. The coupling device according to claim 14, wherein:
the transmission gearing has a single fixed transmission ratio; and/or
the transmission gearing is implemented as an intermediate gear gearing.

16. The coupling device according to claim 14, wherein:
the transmission gearing has a ring, in particular an inner ring, which is coupled in a rotationally-fixed way to the spindle, at least one gearwheel being situated so it is rotatable in or on the ring, the at least one gearwheel engaging on the inner side in a further, in particular inner gearwheel, which is coupled in a rotationally-fixed way to the collet;
the inner ring preferably being enclosed by an outer ring, the outer ring having a peripheral sprocket (or: gear rim) on the inner side, the at least one gearwheel engaging on the outer side in the sprocket (or: gear rim).

17. The coupling device according to one of claim 14, wherein an element which is elastic in the axial direction (A) is situated so it is active between the tool spindle and the thread generation tool.

18. The coupling device according to claim 17, wherein:
the elastic element is formed by a component made of elastomeric material or rubber material; or
the elastic element is formed by a spring element made of spring steel.

19. The coupling device according to one of claim 14, wherein the transmission gearing is situated so it is fixed in place in the rotational direction, preferably also in the opposite rotational direction, but is displaceable in the axial direction (A) using a housing part on a torque support.

20. The coupling device according to claim 19, wherein the torque support comprises a guide rod extending in the axial direction (A), on which a housing part is supported.

21. Decoupling device according to claim 20, wherein a friction or roller bush, in which the guide rod is mounted so it is axially displaceable, is situated on the housing part.

22. The coupling device according to one of claim 14, wherein a coolant duct, which is guided in a coolant pipe in the area of the transmission gearing, runs centrally through the tool spindle to the tool receptacle,
the coolant pipe preferably being mounted in bearings in the tool spindle and in the tool receptacle, the coolant pipe rotating in operation at a rotational speed in relation to the tool spindle and/or the tool receptacle at the level of the difference of the rotational velocity (ω₂) of the tool spindle and the rotational velocity (ω₁) of the tool receptacle, and/or
the coolant pipe preferably being fixed in a rotationally-fixed way on the tool receptacle.

23. A tool machine (or: machine tool) for generating a thread using a thread generation tool, in particular a numerically-controlled machine tool, having a coupling device according to claim 14.

24. The tool machine (or: machine tool) according to claim 23, wherein, using the tool spindle, the (or, a) thread generation tool can be rotated and simultaneously advanced according to the thread pitch in the axial direction (A) in order to generate a thread in a borehole of a workpiece.
